(19) United States
(12) Patent Application Publication
(10) Pub. No.: US 2008/0209317 A1
(43) Pub. Date: Aug. 28, 2008

(54) Invocation of Sponsor-Defined Action on Mobile Communication Device

(75) Inventors: John SanGiovanni, Seattle, WA (US); Benjamin B. Bederson, Chevy Chase, MD (US); James W. Cooley, Redmond, WA (US); Stephen E. Dossick, Seattle, WA (US)

Correspondence Address: FULBRIGHT & JAWORSKI L.L.P, 2200 ROSS AVENUE, SUITE 2800, DALLAS, TX, 75201-2784, US

(73) Assignee: ZENZUI, Seattle, WA (US)

(21) Appl. No.: 11/681,164

(22) Filed: Mar. 1, 2007

Related U.S. Application Data
(60) Provisional application No. 60/891,469, filed on Feb. 23, 2007.

(51) Int. Cl. G06F 3/00

(52) U.S. Cl. 715/700

(57) ABSTRACT

A software application having a graphical user interface (GUI) is provided indicating labeled keys on a keypad of a user's mobile communications device. The GUI has sponsor regions for insertion of various sponsor provided content which may be cached on the communication device. The determination of which sponsors' content to be displayed on the device may be dependant on the content being viewed by the user. The sponsor's content may be inserted into the sponsor region. A selection of the sponsor's content may be made by a user to initiate a user transaction.

### CROSS REFERENCE TO RELATED MATTERS

This application claims benefit of U.S. provisional application No. 60/891,469 filed on Feb. 23, 2007 entitled “Invocation of Sponsor-Defined Action on Mobile Communication Device.”

### BACKGROUND

Content is delivered to mobile communication devices from a many of sources over a wireless network. Traditionally the content may then be viewed using a web browser. To obtain the content, a user is required to enter a web address into the mobile device. Once the user enters the web address, the mobile device sends a request to a service provider to obtain a web page. The web page is downloaded form the service provider and displayed to the user with the web browser.

If the service provider wants to display an advertisement, the advertisement may be displayed as part of a banner on the web page. The user may select the banner using a selection key on a key pad of the mobile device to obtain information about the advertisement. In addition to obtain more advertisement content, the user may have to complete a form. Further the user may be required to navigate to a specialized web page where the user selects a link on the web page to see the advertisement. Downloading of specialized pages or filling out forms may require multiple user interactions with the communications device which are time-consuming and diminishes the user's experience.

### SUMMARY

Use of a mobile communications device to invoke a sponsor defined action is described in this disclosure. A software application having a graphical user interface (GUI) is provided with labeled elements indicating labeled keys on a keypad of the mobile communications device. The GUI has sponsor regions for display of non-sponsored content and insertion of a sponsor GUI containing different sponsor provided content. The sponsor GUI may have labeled elements indicating other labeled keys on the keypad. Sponsor provided content and GUI may be provided directly from one or more sponsors or may be provided along with non-sponsored content from a service provider. The sponsor provided content may be received by, cached on and inserted into the sponsor region on the mobile device. A determination of which sponsors' content to be displayed on the device may be dependant on the content currently being viewed by the user. Other labeled keys on the keypad corresponding to labeled elements of the sponsor provided content may be selected by a user to initiate a user transaction, thereby minimizing the steps required by users to interact with sponsor-defined functionality or services.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 illustrates an exemplary mobile communication device.

FIG. 2 illustrates three different screen displays on a mobile communications device that may be used for invocating sponsor defined actions.

FIG. 3 illustrates a simplified block diagram of a system in which the exemplary mobile communications device may invoke the sponsor defined actions.

FIG. 4 illustrates a simplified block diagram of a mobile communications system having multiple communication devices coupled with a server platform of a service provider.

FIG. 5 illustrates a logical flow diagram illustrating an exemplary process for invocated sponsor defined actions on a mobile communications device.

### DETAILED DESCRIPTION

This disclosure is directed to using a mobile communications device to invoke a sponsor defined action. A software application having a graphical user interface (GUI) is loaded on a mobile communications device. The application indicates applications that can be invoked on the mobile device and may display content data. Also instantiated on a mobile device display with the GUI are labeled elements that may be identical to labels keys on a keypad of the mobile communications device. The GUI has sponsor defined regions for insertion by the mobile device of a sponsor GUI that includes sponsor provided content. The sponsor GUI may display labeled elements identical to other labeled keypad keys. The sponsor GUI may be received and cached on the mobile device for insertion by the mobile device into the sponsor defined region. A user may then select with the keypad the other labeled keys to automatically initiate a user transaction, such as a purchase of a song, a download of data or an order to purchase goods.

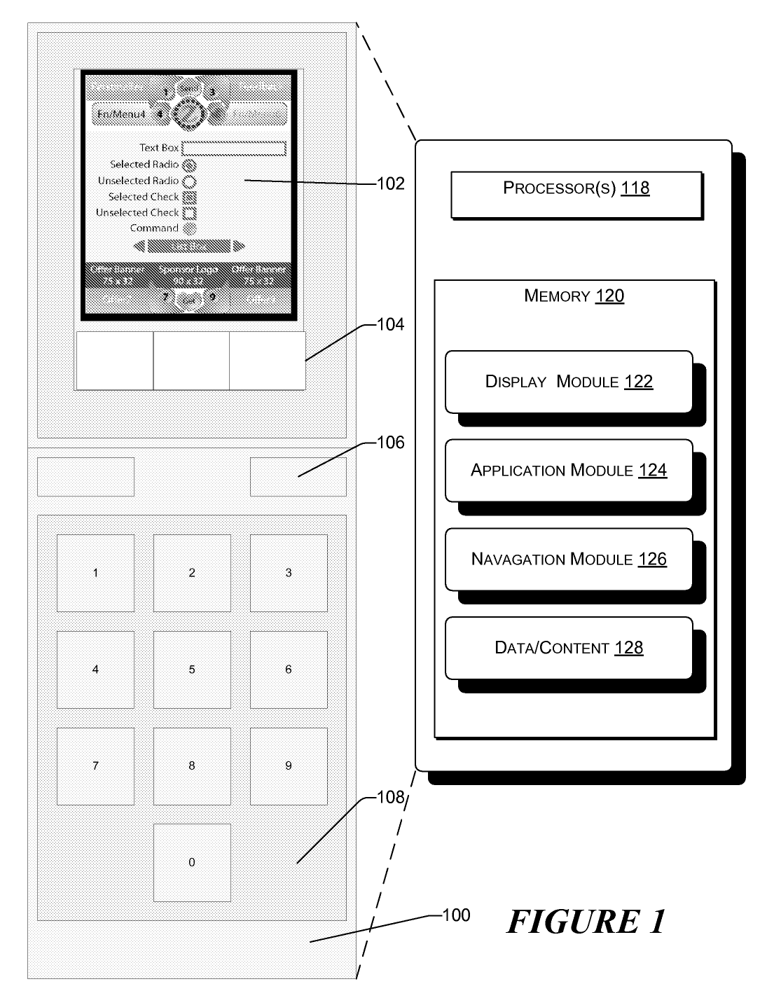

These techniques help provide a mechanism for accessing sponsor defined (and hosted) functionality or services and tying those user interface elements on a mobile communications terminal in an easy to locate and access manner. Various examples of invocating sponsor-defined actions on a mobile communication device are described below with reference to FIGS. 1-5.

### Example System Architecture

FIG. 1 illustrates an example mobile communications device 100 in which elements on display 102 may be invoked using soft key 104, soft key 106 or keys on keypad 108. Mobile communications device 100 may include a processor 118 and memory 120. Stored within memory 120 are display module 122, application module 124, navigation module 126 and data/content 128.

Display module 122 may display content on screen or display 102 in accordance with commands provided by application module 124. Application module 124 generates a Graphical User Interface (GUI) and receives content/data from a server over a network, such as the internet. Application module 124 may include other applications that can be launched in response to a user activating applications shown on display 102. Navigation module 126 enables the user to move between different tiles shown on screen using a process, such as the process described in co-pending U.S. patent application Ser. No. 11/061,218, filed Feb. 18, 2005, which is hereby incorporated by reference.

Data/Content 128 may be stored in memory 120 and may be provided from a service provider. Data/content 128 may be received content/data that can be displayed on device 100 and may include advertisement sponsored content. Content 128 may include, for example, sponsor provided content or non-sponsor content.

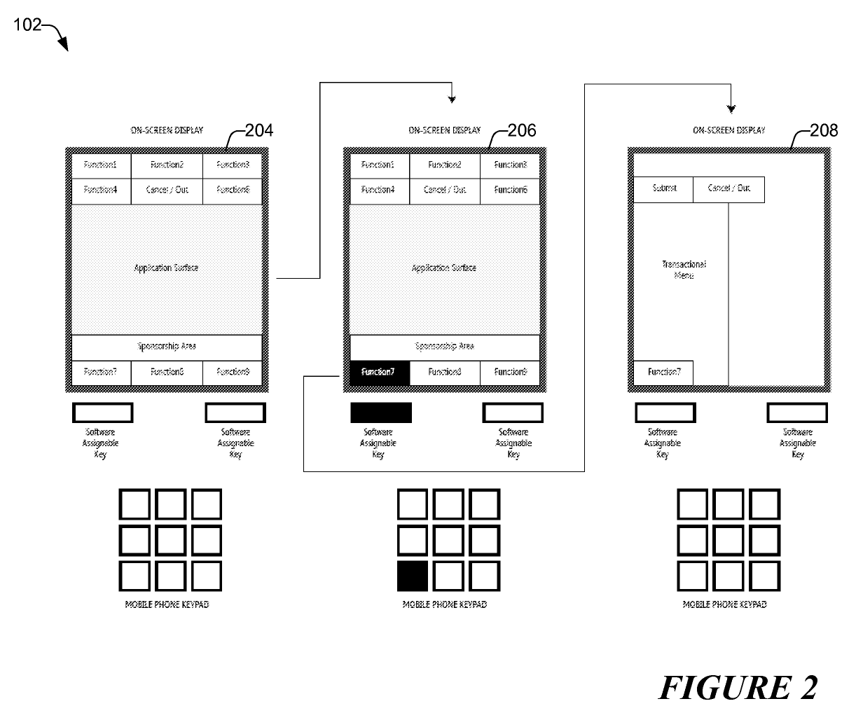

Referring to FIG. 2, there is shown screen 102 having exemplary multiple on-screen displays 204-208. Displays 204-208 are shown in sequence demonstrating the invocation of sponsor defined actions on a mobile communications device. Such displays 204-208 may all be simultaneously cached in memory of the mobile communications device. After content/data is received, it may be instantiated on a screen 102 in the format shown in screen display 204. Functions on the screen may be assigned to an adjacent software assignment key (soft key) that can be selected by a user. For some communications devices, the functions may be selected by depressing the function label on the screen 102. Additionally or alternatively the functions shown on the screen 102 may be indicate a number identical to a number on a keypad of the mobile communication device 100.

When the soft key or number on the keypad is depressed as shown in display 206, a function is invoked. This function may be a sponsor provided function that is inserted into a specific region of the screen display so that the screen display shows both the sponsor portion of the display along with the non-sponsor content. When the soft key or number on the keypad 108 is invoked on screen 206, another screen display 208 may be instantiated to automatically launch a transaction. This transaction may have a confirmation screen or in one embodiment may be invoked automatically by the service provider. Upon invoking of the transaction a signal may be transmitted from the mobile communications device 100 to the service provider. As a result of receiving the signal, the service provider may initiate a transaction. Examples of the transaction may include initiating a download of a digital audio recording from a server to the mobile communication device 100, and initiating a delivery of a product to a user.

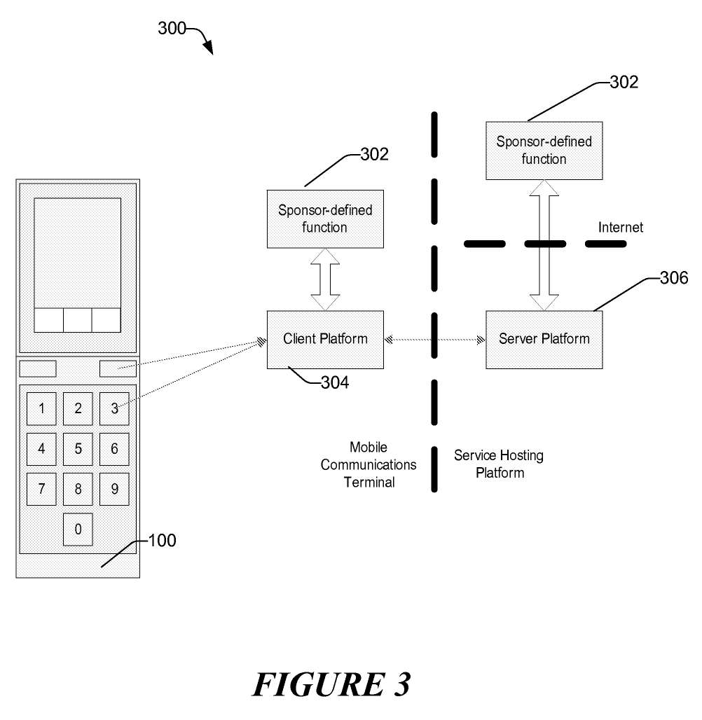

Referring to FIG. 3, there is shown a system 300 having communications device 100 with a client platform application 304 and a sponsor device function. The sponsor device function 302 may be the sponsor GUI that is received from server platform 306. The sponsor defined function 302 may be received by the server platform via the internet from a 3^{rd} party sponsor or directly from a third party sponsor. The sponsor defined function 302 may be in a predetermined format and transmitted to server platform 306 from the third party. When the client platform 304 request content from the server platform 306, the sponsored defined function 302 may be downloaded to the client platform 304 and be stored locally in memory 120 of the mobile communications device 100.

The client platform application 304 may integrate the sponsor defined function 302 with other content (non-sponsor content) for display on the communications device 100. Further when the user of device 100 selects the displayed sponsor defined function 302, the client platform application 304 may send a request to server platform 306. The request may then be fed over the internet to the sponsor-defined function 302 on the third party's server. The third party server may then reply to the request by delivering the sponsor defined function (content) to server platform 306 for delivery to the mobile communications terminal 100.

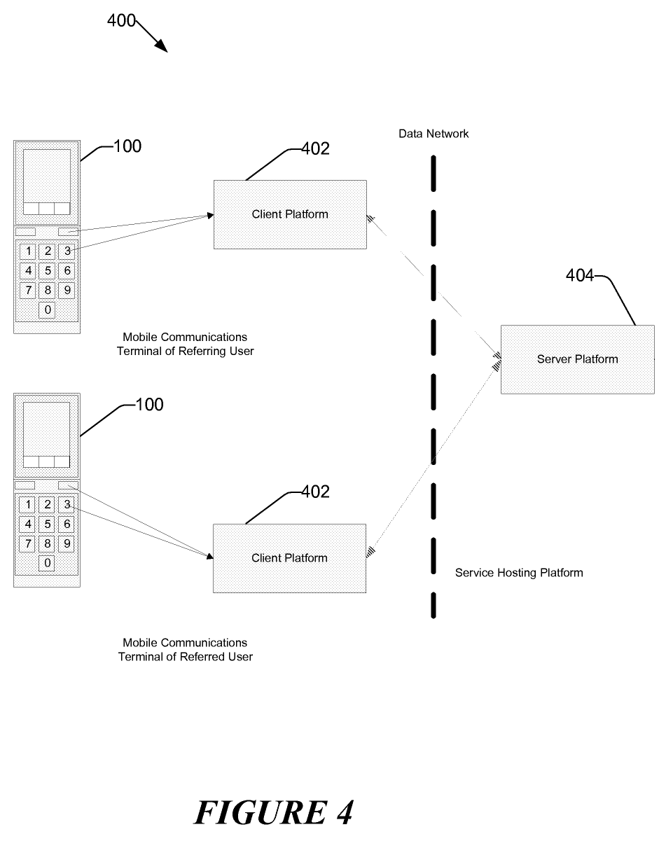

Referring to FIG. 4, there is shown a system 400 having multiple communications terminals 100 each having a corresponding client platform applications 402 coupled via a data network to a server platform 404. Server platform 404 may be the server platform 306 shown in FIG. 3.

Users of the communications terminals 100 enter commands by selecting functions, which are processed by client platform application 402. In response to some commands, client platform application 402 sends requests to server platform 404. Platform 404 responds to the requests by delivering data/content to client platform application 402 or providing an indication to a sponsor server to initiate a transaction.

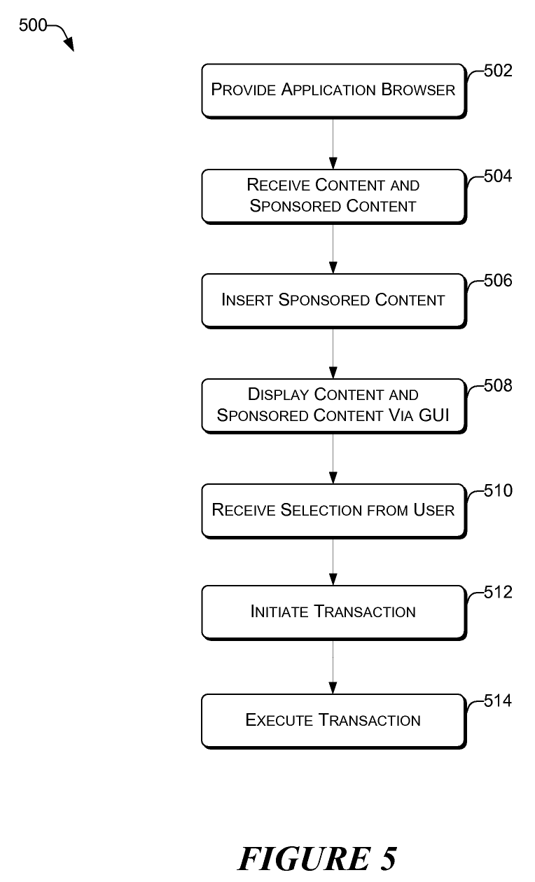

Illustrated in FIG. 5 is a flow diagram of a process 500 to invoke a sponsor defined action on a mobile communication device. In this process 500, a web browser or other GUI application is installed as application module 124 on the communication device in block 502. Such application should be capable of displaying and managing content provided from a service provider.

The application, in response to input from a user using a keypad or upon selections of tiles as described previously, receives content along with many different types of sponsor provided content from the service provider in block 504. In one embodiment the service provider may receive the sponsored content from the third party sponsor. Such content may be cached locally in memory 120 of the mobile communications terminal 100. The sponsored content may be inserted into a region of the GUI of an application in block 506. Such inserted sponsored content may be displayed with other user provided content. The type (e.g. genre, advertiser, subject, etc.) of sponsored content may be selected to be displayed in block 506. The selection may be dependent on or related to the type of non-sponsor content the user is viewing and the sponsor provided content's relationship to the non-sponsor content. For example if the user is viewing movies on the communication device's display, sponsored content related to movies (e.g. new movie release information) may be displayed. However, if content relating to cars is being displayed on the mobile device, sponsored content relating to cars (a special car promotion discount) may be displayed on the mobile device.

The communication device, in block 510, may receive a selection of sponsored content in response to a user selecting a key on a keypad or soft key as previously described. In response to such a selection, the application on the communications device 100 may initiate a transaction in block 512 by sending an initiation request to the service provider. Initiating of the transaction may result in the transaction being executed on server of service provider in block 514 as previously described.

### CONCLUSION

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for invoking a sponsor defined action on a mobile communications device comprising:
displaying with an application having a graphical user interface (GUI) content comprising a plurality of labeled elements that indicate labeled keys on a input device of the mobile communications device, said graphic user interface having sponsor defined regions;
receiving a sponsor GUI indicating sponsor provided content, said sponsor GUI having labeled elements indicating other labeled keys on the input device;
inserting the sponsor GUI into the sponsor defined region;
selecting with the input device one of the other labeled keys; and
initiating a user transaction when other labeled keys on the input device is selected.

2. The method as recited in claim 1 wherein the user transaction is selected from a group of transactions comprising initiating a transaction acknowledgment GUI, initiating a download of a digital audio recording from a server to the mobile communication device, and initiating a delivery of a product to a user.

3. The method as recited in claim 1 wherein the application and the sponsor GUI is provided from a service provider.

4. The method as recited in claim 1 wherein the GUI elements are provided in response to selection of a tile on a second GUI.

5. The method as recited in claim 2 wherein the both the application and the sponsor GUI are cached in the mobile device before the user transaction is initiated.

6. The method as recited in claim 1 wherein the labeled keys are on a keypad of the mobile device and wherein the labeled elements indicate the labeled keys by having identical symbols as the labeled keys.

7. A computer readable medium comprising computer-executable instructions that, when executed by one or more processors, perform acts comprising:
receiving non-sponsored content with a graphic user interface (GUI) including a sponsor defined region, said GUI having labeled elements indicating keys on an input device of a mobile communications device corresponding to the sponsor defined region and non-sponsored content;
receiving a plurality of sponsor provided content;
selecting with the input device non-sponsored content to be displayed;
inserting the sponsor provided content into the sponsor defined region;
selecting the keys corresponding to the sponsor provided content in the sponsor defined region; and
initiating a user transaction when keys corresponding to the sponsor provided content in the sponsor defined region is selected.

8. The computer readable media as recited in claim 7 further comprising storing sponsored content and non-sponsored content in cache memory of the mobile communication device.

9. The computer readable media as recited in claim 7 wherein the sponsor provided content is inserted into the sponsor defined region depending on content selected.

10. The computer readable media as recited in claim 7 wherein the input device is a keypad; and wherein the keys are labeled.

11. The computer readable media as recited in claim 7 wherein the sponsor provided content originates from different source than non-sponsored content.

12. The computer readable media as recited in claim 7 wherein the user transaction is selected from a group of transactions comprising: initiating a transaction acknowledgment GUI, initiating a download of a digital audio recording from a service provider to the mobile communication device, and initiating a delivery of a product to a user.

13. A system comprising:
a service provider to deliver to a mobile communications device an application having a graphical user interface (GUI) and sponsor and non-sponsored content comprising a plurality of labeled elements that indicate labeled keys on a input device of the mobile communications device, said GUI having sponsor defined regions; and
the mobile communications device to receive the application and request content from the service provider in response to a user selecting content with the input device, the mobile communications device to receive sponsor provided content and insert the labeled elements of sponsor provided content with non-sponsored content into the sponsor define regions of the GUI, the mobile communications device to receive a selection with the input device of one of the labeled keys and to initiate a user transaction when labeled keys on the input device corresponding to the labeled elements of the sponsor provided content is selected.

14. The system as recited in claim 13, wherein the mobile communications device is operative to transmit a signal to the service provider to initiate the user transaction.

15. The system as recited in claim 14, wherein the user transaction is selected from a group of transactions comprising: initiating a transaction acknowledgment GUI, initiating a download of a digital audio recording from a service provider to the mobile communication device, and initiating a delivery of a product to a user.

16. The system as recited in claim 14 wherein the sponsor provided content is provided to the service provider from different source than a provider or the non-sponsored content.

17. The system as recited in claim 14 wherein the sponsor provided content is inserted into the sponsor defined region depending on non-sponsored content selected.

18. The system as recited in claim 14 wherein said GUI has labeled elements identical to labeled keys on the input device.

19. A computer readable medium comprising computer-executable instructions that, when executed by one or more processors, perform acts comprising:
providing content to a mobile communications device having an application with a graphical user interface (GUI), the application display a plurality of labeled elements that depict labeled keys on a input device of the mobile communications device, said GUI having a sponsor region;
sending a plurality of sponsor provided content to the mobile communications device for insertion into the sponsor defined region such that when the sponsor defined content is inserted into the sponsor region and displayed, the sponsor defined content is displayed with labeled elements;
receiving a request to initiate a user transaction from the mobile communication device in response to a user selection with the labeled keys of the input device that correspond to the labeled elements of the sponsor provided content; and
in response to the request, transmitting an indication request to a third party service provider to complete the user transaction.

20. The computer readable medium as recited in claim 14, wherein one of the plurality of sponsor provided content is selected and inserted into the sponsor region depending on non-sponsored content selected.
